(19) United States
(12) Patent Application Publication
(10) Pub. No.: US 2022/0107592 A1
(43) Pub. Date: Apr. 7, 2022

(54) IMAGE FORMING APPARATUS

(71) Applicant: FUJIFILM Business Innovation Corp., Tokyo (JP)

(72) Inventors: Koichiro Yuasa, Kanagawa (JP); Kazuki Kishi, Kanagawa (JP); Yoko Miyamoto, Kanagawa (JP); Toshiaki Baba, Kanagawa (JP); Tomoaki Yoshioka, Kanagawa (JP)

(73) Assignee: FUJIFILM Business Innovation Corp., Tokyo (JP)

(21) Appl. No.: 17/320,937

(22) Filed: May 14, 2021

(30) Foreign Application Priority Data
Oct. 2, 2020 (JP) 2020-167884

(51) Int. Cl. G03G 15/16; G03G 15/02; G03G 15/08

(52) U.S. Cl. CPC G03G 15/1655; G03G 15/0805; G03G 15/0225

(57) ABSTRACT

An image forming apparatus includes: a rotating body having a recess in an outer peripheral surface thereof; a transfer portion that is in contact with the outer peripheral surface of the rotating body, the transfer portion being configured to transfer a toner to a recording medium passing between the rotating body and the transfer portion; and a brush configured to come into contact with the outer peripheral surface of the rotating body to remove a toner adhering to the outer peripheral surface.

### CROSS-REFERENCE TO RELATED APPLICATIONS

This application is based on and claims priority under 35 USC 119 from Japanese Patent Application No. 2020-167884 filed Oct. 2, 2020.

### BACKGROUND

### (i) Technical Field

The present disclosure relates to an image forming apparatus.

### (ii) Related Art

JP-A-58-005769 discloses a transfer device for transferring an image on an image carrier. The transfer device includes a transferred material transporting unit, a gripper piece, and a switch member. The transferred material transporting unit moves a transferred material in an endless manner along a circulating movement path. The gripper piece is attached to the transporting unit. The gripper piece is pivotally supported by a rotating shaft. The gripper piece rotates relative to a base member. The gripper piece holds a leading end side of the transferred material. The switch member is attached to a base member side. In order to detect whether the transferred material is in the gripper, a part of a switch member position in the gripper piece is cut out.

### SUMMARY

Consider an image forming apparatus that includes a rotating body having a recess on an outer peripheral surface thereof, and a transfer portion that is in contact with the outer peripheral surface of the rotating body and transfers a toner to a recording medium passing between the rotating body and the transfer portion. In this configuration, when a blade is pressed against the outer peripheral surface of the rotating body to remove a toner adhering to the outer peripheral surface, since the recessed is formed in the outer peripheral surface of the rotating body, the blade may collide with an edge of the recessed, thereby vibrating the rotating body and the blade. When the rotating body and the blade vibrate, the toner adhering to the rotating body and the blade may get blown up, the toner may adhere to a non-transfer surface of the recording medium passing between the transfer portion and the rotating body, and the non-transfer surface may be contaminated.

Aspects of non-limiting embodiments of the present disclosure relate to preventing contamination of a non-transfer surface of a recording medium as compared to a configuration in which a blade is pressed against an outer peripheral surface of a rotating body to remove a toner adhering to the outer peripheral surface.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a rotating body having a recess in an outer peripheral surface thereof; a transfer portion that is in contact with the outer peripheral surface of the rotating body, the transfer portion being configured to transfer a toner to a recording medium passing between the rotating body and the transfer portion; and a brush configured to come into contact with the outer peripheral surface of the rotating body to remove a toner adhering to the outer peripheral surface.

### BRIEF DESCRIPTION OF THE DRAWINGS

Exemplary embodiment(s) of the present disclosure will be described in detail based on the following figures, wherein:

FIG. 1 is a schematic view showing a configuration of an image forming apparatus according to an exemplary embodiment;

FIG. 2 is a perspective view showing a configuration around a transfer cylinder according to the exemplary embodiment;

FIG. 3 is a perspective view showing grippers according to the exemplary embodiment:

FIG. 4 is a schematic view showing a configuration of a cleaning device and the transfer cylinder according to the exemplary embodiment;

FIG. 5 is an enlarged view showing a configuration of the cleaning device according to the exemplary embodiment:

FIG. 6 is a schematic view showing a state in which a body of a cleaning device according to the exemplary embodiment is located at a separated position:

FIG. 7 is a schematic view showing a brush and a flicker according to the exemplary embodiment;

FIG. 8 is a schematic view showing a state in which a recess of the transfer cylinder opposes the brush in the cleaning device according to the exemplary embodiment;

FIG. 9 is a schematic view showing ducts of the cleaning device according to the exemplary embodiment:

FIG. 10 is a schematic view showing a partition plate of the cleaning device according to the exemplary embodiment:

FIG. 11 is a schematic view showing a front cover of a body of the image forming apparatus according to the exemplary embodiment;

FIG. 12 is a schematic view showing a state in which the front cover of the body of the image forming apparatus according to the exemplary embodiment is opened;

FIG. 13 is a perspective view showing a detachable unit according to the exemplary embodiment; and

FIG. 14 is a perspective enlarged view showing a part of the detachable unit according to the exemplary embodiment.

### DETAILED DESCRIPTION

Hereinafter, an example of an exemplary embodiment according to the present disclosure will be described with reference to the accompanying drawings.

### Image Forming Apparatus 10

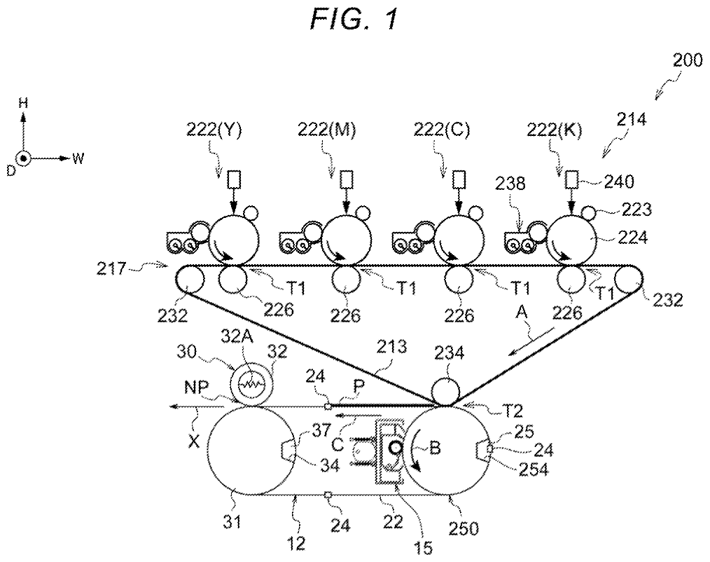

A configuration of an image forming apparatus 10 according to the present exemplary embodiment will be described. FIG. 1 is a schematic view showing the configuration of the image forming apparatus 10 according to the present exemplary embodiment. In the drawings, an arrow H indicates an apparatus height direction which is a vertical direction, an arrow W indicates an apparatus width direction which is one of horizontal directions, and an arrow D indicates an apparatus depth direction which is another one of the horizontal directions (a front to rear direction of the apparatus). In particular, when an arrow indicating a rear side of the image forming apparatus 10, the reference sign “DR” is added. Dimensional ratios in the H direction, the W direction, and the D direction of respective elements shown in the respective drawings may be different from actual dimensional ratios.

The image forming apparatus 10 shown in FIG. 1 is an electrophotographic image forming apparatus that forms a toner image (an example of an image) on a recording medium P. Specifically, the image forming apparatus 10 includes an image forming unit 214, a fixing device 30, a transport mechanism 12, and a cleaning device 15. Hereinafter, each of elements (that is, the image forming unit 214, the fixing device 30, the transport mechanism 12, and the cleaning device 15) of the image forming apparatus 10 will be described.

### Image Forming Unit 214

The image forming unit 214 has a function of forming a toner image (an example of an image) on a recording medium P by an electrophotographic technique. Specifically, as shown in FIG. 1, the image forming unit 214 includes toner image forming units 222 that form toner images, and a transfer device 217 that transfers the toner images formed by the toner image forming units 222 to the recording medium P.

### Toner Image Forming Unit 222

The toner image forming units 222 shown in FIG. 1 are provided so as to form toner images of respective colors. In the present exemplary embodiment, the toner image forming unit 222 of four colors of yellow (Y), magenta (M), cyan (C), and black (K) are provided. (Y), (M), (C), and (K) shown in FIG. 1 represent components corresponding to the respective colors described above.

Since the toner image forming units 222 of the respective colors have similar configuration except for a toner used therein, the reference numerals are given to the respective elements of the toner image forming unit 222(K) in FIG. 1 as a representative of the toner image forming units 222 of the respective colors.

Specifically, the toner image forming unit 222 of each color includes a photoconductor 224 that rotates in one direction (for example, a counterclockwise direction in FIG. 1). The toner image forming unit 222 of each color includes a charging unit 223, an exposure device 240, and a developing device 238.

In the toner image forming unit 222 of each color, the charging unit 223 charges the photoconductor 224. Further, the exposure device 240 exposes the photoconductor 224 charged by the charging unit 223 to form an electrostatic latent image on the photoconductor 224. The developing device 238 develops the electrostatic latent image formed on the photoconductor 224 by the exposure device 240, to form a toner image.

### Transfer Device 217

The transfer device 217 shown in FIG. 1 is a device that transfers the toner image formed by the toner image forming unit 222 to the recording medium P. Specifically, the transfer device 217 primarily transfers the toner images of the photoconductors 224 of the respective colors onto a transfer belt 213 (as an intermediate transfer body) in a superimposed manner, and secondarily transfers the superimposed toner images onto the recording medium P. As shown in FIG. 1, the transfer device 217 includes the transfer belt 213, primary transfer rollers 226, and a transfer cylinder 250. The transfer cylinder 250 is an example of a rotating body, and the transfer belt 213 is an example of a transfer portion.

Each primary transfer roller 226 is a roller that transfers the toner image of the photoconductor 224 of the corresponding color to the transfer belt 213 at a primary transfer position T1 between the photoconductor 224 and the primary transfer roller 226. In the present exemplary embodiment, a primary transfer electric field is applied between the primary transfer roller 226 and the photoconductor 224, so that the toner image formed on the photoconductor 224 is transferred to the transfer belt 213 at the primary transfer position T1.

The toner images are transferred from the photoconductors 224 of the respective colors to the outer peripheral surface of the transfer belt 213. As shown in FIG. 1, the transfer belt 213 has an endless shape. The transfer belt 213 is wound on plural rollers 232 and an opposing roller 234 so as to have an inverted triangle shape in a front view (as viewed in the apparatus depth direction). The transfer belt 213 circulates in a direction of an arrow A as at least one of the plural rollers 232 is rotationally driven.

The transfer cylinder 250 is a transfer body that transfers the toner image transferred to the transfer belt 213 to the recording medium P at a secondary transfer position T2 between the opposing roller 234 and the transfer cylinder 250. As shown in FIG. 1, the transfer cylinder 250 is disposed below the transfer belt 213 and opposes the transfer belt 213. The transfer cylinder 250 is formed in a circular shape in a side view and has a recess 254 in an outer peripheral surface thereof. Grippers 24 and an attachment member 23, which will be described later, are accommodated in the recess 254. As a result, when the grippers 24 and the attachment member 23 pass through the secondary transfer position T2, the grippers 24 and the attachment member 23 are prevented from coming into contact with the transfer belt 213. A specific configuration of the recess 254 will be described later.

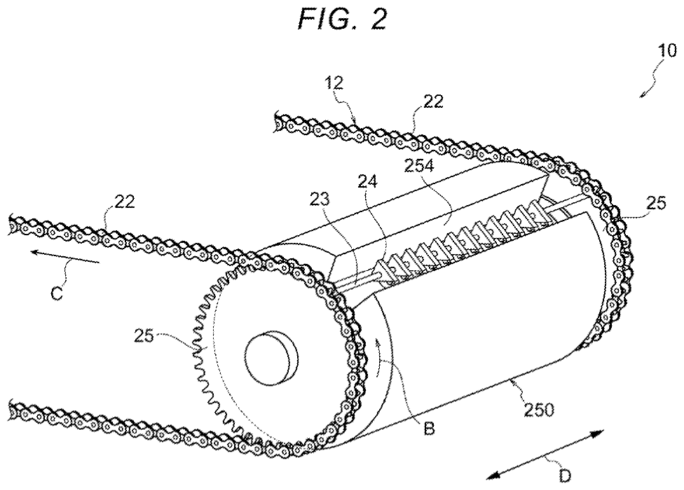

As shown in FIG. 2, a pair of sprockets 25 is provided at both end portions, in an axial direction, of the transfer cylinder 250. The pair of sprockets 25 is disposed coaxially with the transfer cylinder 250, and rotate integrally with the transfer cylinder 250. The transfer cylinder 250 and the pair of sprocket 25 are rotationally driven by a driving unit (not illustrated). Hereinafter, the axial direction of the transfer cylinder 250 may be simply referred to as an “axial direction”.

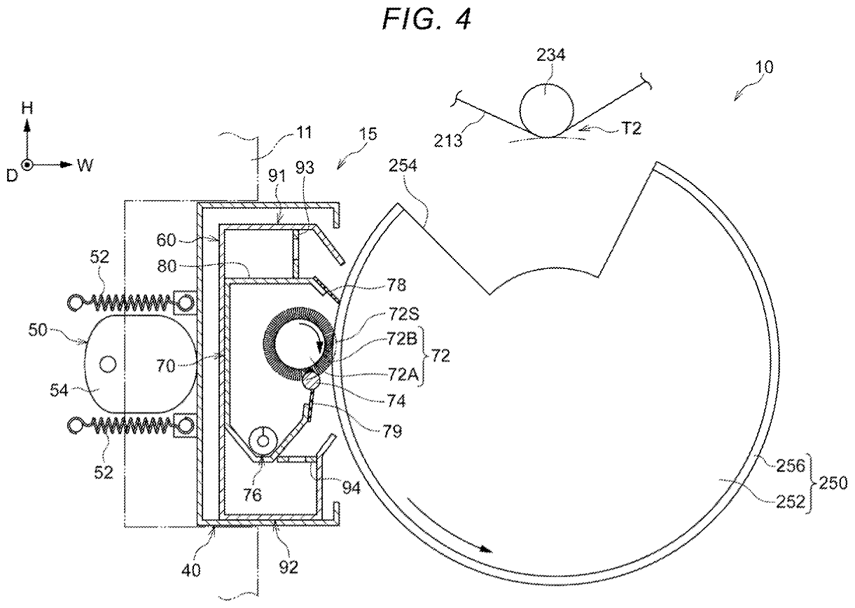

More specifically, as shown in FIG. 4, the transfer cylinder 250 includes a cylinder body 252 and an elastic layer 256. The cylinder body 252 is made of a metal material such as stainless steel or aluminum. The elastic layer 256 is wound around an outer periphery of the cylinder body 252. As the elastic layer 256, for example, a rubber layer made of a foamed rubber is used.

In the present exemplary embodiment, when a secondary transfer electric field is applied between the opposing roller 234 and the transfer cylinder 250, the toner image transferred to the transfer belt 213 is transferred to the recording medium P at the secondary transfer position T2. The transfer belt 213 and the outer peripheral surface of the transfer cylinder 250 are in contact with each other at the secondary transfer position T2. The toner image is transferred while the transfer belt 213 and the transfer cylinder 250 transport the recording medium P in a state of nipping the recording medium P at the secondary transfer position T2.

### Fixing Device 30

In the present exemplary embodiment, the fixing device 30 functions as a device that fixes the toner image transferred to the recording medium P by the transfer cylinder 250 to the recording medium P. Specifically, as shown in FIG. 1, the fixing device 30 includes a pressure roller 31 and a heating roller 32.

In the fixing device 30, the heating roller 32 is disposed above the pressure roller 31. The heating roller 32 has a heating source 32A such as a halogen lamp inside the heating roller 32.

The pressure roller 31 has a recess 34 in an outer peripheral surface thereof. One recess 34 is provided in a part of the outer peripheral surface of the pressure roller 31 in a circumferential direction. Further, the recess 34 is elongated along the axial direction of the pressure roller 31 and has a depth along a radial direction of the pressure roller 31. The grippers 24 and the attachment member 23, which will be described later, are accommodated in the recess 34. As a result, when the grippers 24 and the attachment member 23 pass through a fixing position NP shown in FIG. 1, the grippers 24 and the attachment member 23 are prevented from coming into contact with the heating roller 32.

A pair of sprockets 37 is provided at both axial end portions of the pressure roller 31. The pair of sprockets 37 is disposed coaxially with the pressure roller 31, and rotate integrally with the pressure roller 31.

The fixing device 30 fixes the toner image transferred to the recording medium P to the recording medium P by heating and pressing the recording medium P while transporting the recording medium P in a state in which the recording medium P is sandwiched at the fixing position NP between the heating roller 32 and the pressure roller 31.

### Transport Mechanism 12

The transport mechanism 12 shown in FIG. 1 is a mechanism that transports the recording medium P. As shown in FIGS. 1 and 2, the transport mechanism 12 includes a pair of chains 22, and the grippers 24. In FIG. 1, one of the chains 22 is shown, and the chain 22 and the grippers 24 are shown in a simplified manner.

As shown in FIG. 1, each of the chains 22 is formed in an annular shape. As shown in FIG. 2, the chains 22 are arranged at an interval in the apparatus depth direction (that is, a D direction in FIG. 2). Each of the chains 22 is wound on a respective one of the sprockets 25 and a respective one of the sprockets 37 (see FIG. 1). The sprockets 25 are provided at both ends, in the axial direction, of the transfer cylinder 250. The sprockets 37 are provided at both ends, in the axial direction, of the pressure roller 31. The transfer cylinder 250 and the pair of sprockets 25 are integrally rotationally driven in a rotation direction B (a direction of the arrow B), and thereby the chain 22 circulates in a circulating direction C (a direction of the arrow C).

As shown in FIG. 2, an attachment member 23 to which grippers 24 are attached bridges between the chains 22 along the apparatus depth direction. The plural attachment members 23 are fixed to the pair of chains 22 at predetermined intervals along the circulating direction C of the chains 22.

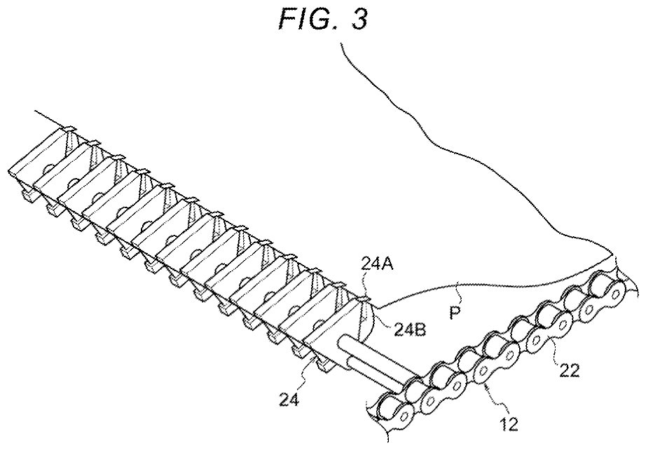

As shown in FIG. 2, the plural grippers 24 are attached to the attachment member 23 at predetermined intervals along the apparatus depth direction. The gripper 24 functions as a holder that holds a leading end portion of the recording medium P. Specifically, as shown in FIG. 3, the gripper 24 includes a pawl 24A and a pawl base 24B. The gripper 24 holds the recording medium P by sandwiching the leading end portion of the recording medium P between the pawl 24A and the pawl base 24B. In the gripper 24, for example, the pawl 24A is pressed against the pawl base 24B by a spring, and the pawl 24A is opened from and closed to the pawl base 24B by the action of a cam.

In the transport mechanism 12, as shown in FIG. 3, the grippers 24 hold the leading end portion of the recording medium P sent from an accommodating unit (not illustrated) that accommodates recording media P. The chains 22 circulate in the circulating direction C, so that the grippers 24 holding the leading end portion of the recording medium P transports the recording medium P and causes the recording medium P to pass through the secondary transfer position T2 and the fixing position NP. Then, the toner images primarily transferred onto the transfer belt 213 in the superimposed manner at the primary transfer positions T1 of the respective colors are secondarily transferred onto the recording medium P at the secondary transfer position T2. The toner image secondarily transferred to the recording medium P is fixed to the recording medium P at the fixing position NP.

When the grippers 24 pass through the secondary transfer position T2, the grippers 24 and the attachment member 23 are accommodated in the recess 254 formed in the outer peripheral surface of the transfer cylinder 250. When the grippers 24 pass through the fixing position NP, the grippers 24 and the attachment member 23 are accommodated in the recess 34 formed in the outer peripheral surface of the pressure roller 31.

### Cleaning Device 15

The cleaning device 15 shown in FIG. 4 is a device that cleans the outer peripheral surface of the transfer cylinder 250. Specifically, the cleaning device 15 is a device that removes a toner adhering to the outer peripheral surface of the transfer cylinder 250. As shown in FIG. 4, the cleaning device 15 includes a body 40, a moving mechanism 50, a duct frame 60, and a detachable unit 70. In the present exemplary embodiment, the outer peripheral surface of the transfer cylinder 250 is a surface of the elastic layer 256.

### Body 40 of Cleaning Device 15 and Moving Mechanism 50

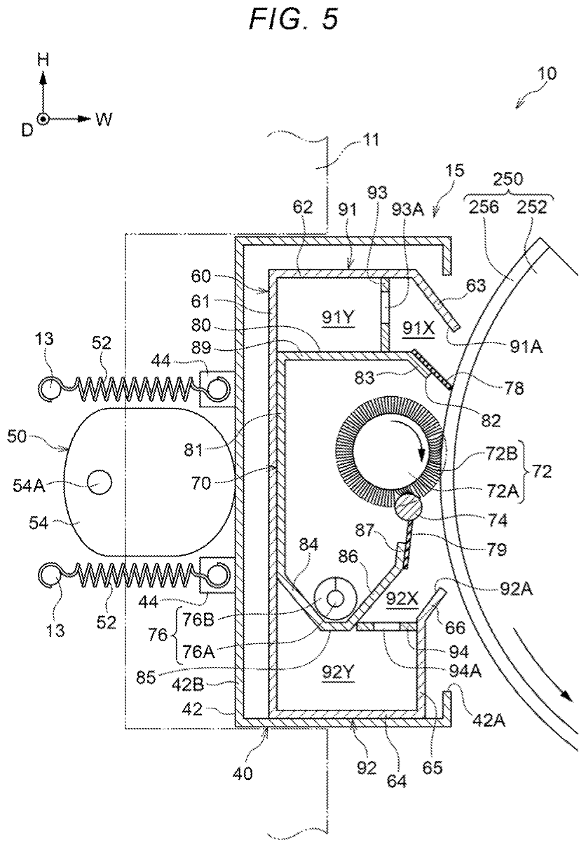

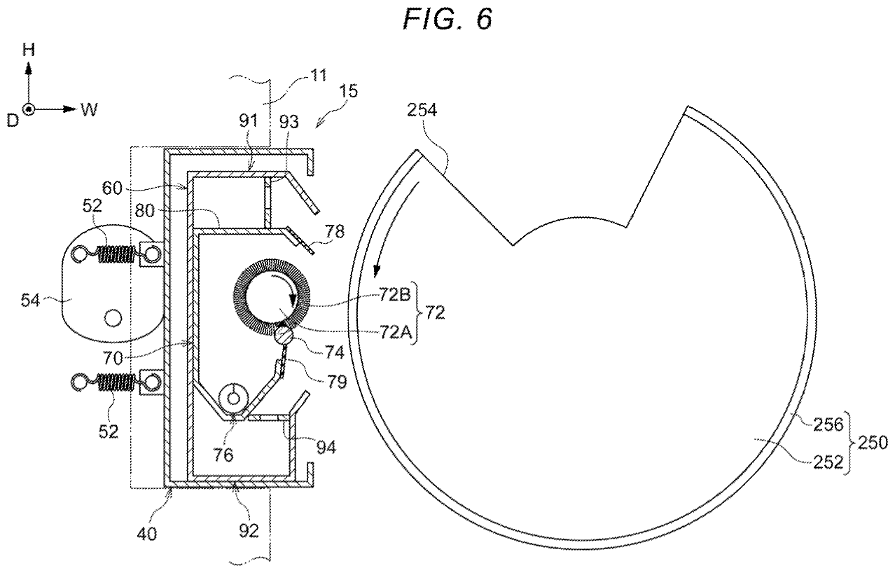

As shown in FIG. 5, the body 40 includes a box-shaped housing 42 and attachment portions 44. The housing 42 is formed in a substantially rectangular parallelepiped shape and is elongated along the axial direction. The housing 42 has an opening 42A that opens toward the transfer cylinder 250 (that is, opens rightward in FIG. 5). In the present exemplary embodiment, the body 40 of the cleaning device 15 is provided in a body 11 of the image forming apparatus 10 such that the body 40 is movable along the apparatus width direction together with the duct frame 60 and the detachable unit 70. Specifically, the body 40 is movable along the apparatus width direction between an approach position shown in FIG. 4 and a separated position shown in FIG. 6.

When the body 40 is located at the approach position and the outer peripheral surface of the transfer cylinder 250 opposes the brush 72, the brush 72 is in contact with the outer peripheral surface of the transfer cylinder 250. When the outer peripheral surface of the transfer cylinder 250 opposes a seal member 78 (which will be described later), the seal member 78 is in contact with the outer peripheral surface of the transfer cylinder 250. When the body 40 is located at the separated position, the brush 72 is separated from the outer peripheral surface of the transfer cylinder 250.

As shown in FIG. 5, each attachment portion 44 is a part to which a tension spring 52, which will be described later, of the moving mechanism 50 is attached. Two attachment portions 44 are provided on a side wall 42B of the housing 42 on a side opposite to the transfer cylinder 250 (on a left side in FIG. 5).

The moving mechanism 50 is a mechanism that moves the body 40 between the approach position shown in FIG. 4 and the separated position shown in FIG. 6. Specifically, as shown in FIG. 5, the moving mechanism 50 includes the two tension springs 52 and a cam 54. One end portion of each of the two tension springs 52 is attached to a respective one of the attachment portions 44. The other end portion of each of the two tension springs 52 is attached to a respective one of attachment portions 13 provided in the body 11 of the image forming apparatus 11. As a result, the two tension springs 52 pull the cleaning device body 40 toward the separated position (leftward in FIG. 5) relative to the approach position. The cam 54 is provided in the body 11 so as to be swingable about a swing shaft 54A. In the moving mechanism 50, when the cam 54 swings and a longer diameter portion of the cam 54 comes into contact with the side wall 42B of the housing 42, the body 40 is moved to the approaching position shown in FIG. 4 against an elastic force of the tension springs 52.

In the moving mechanism 50, when the cam 54 swings and a shorter diameter portion of the cam 54 opposes the side wall 42B of the housing 42, the body 40 is moved to the separated position shown in FIG. 6 by the elastic force of the tension springs 52.

### Duct Frame 60 and Detachable Unit 70

As shown in FIG. 5, the duct frame 60 and the detachable unit 70 are disposed inside the housing 42 of the body 40.

The detachable unit 70 is removable in the front to rear direction relative to the body 40 of the cleaning device 15 provided in the body 11 of the image forming apparatus 10. Specifically, the detachable unit 70 is detached from the body 11 of the image forming apparatus 10 by being pulled out from the body 40 of the cleaning device 15 to a front side (that is, being pulled out of the paper of FIG. 5). The detachable unit 70 is attached to the body 40 of the cleaning device 15 by being inserted into the body 40 from the front side to a rear side (that is, being inserted into the paper of FIG. 5). In this manner, the detachable unit 70 is detachably attached to the body 11 of the image forming apparatus 10.

Specifically, the detachable unit 70 includes a box-shaped housing 80, a brush 72, a flicker 74, a transport auger 76, and seal members 78 and 79. The flicker 74 is an example of a contact member, and the transport auger 76 is an example of a transport member.

The housing 80 is formed in a substantially rectangular parallelepiped shape and is elongated along the axial direction. The housing 80 has an opening 82 that opens toward the transfer cylinder 250 (rightward in FIG. 5). Specifically, the housing 80 includes, for example, a side wall 81, an upper wall 89, an upper edge 83, inclined walls 84 and 86, a bottom wall 85, and a lower edge 87.

The side wall 81 is disposed on an opposite side (that is, on the left side in FIG. 5) of the brush 72 to the transfer cylinder 250. The side wall 81 is formed in a plate shape and extends in the height direction as viewed in the front to rear direction. The upper wall 89 is formed in a plate shape and extends from an upper end of the side wall 81 toward the transfer cylinder 250 (that is, the right side in FIG. 5) when viewed in the front to rear direction. The upper edge 83 is formed in a plate shape and extends obliquely downward from a right end of the upper wall 89 (an end on the transfer cylinder 250 side; the same applies hereinafter) toward the transfer cylinder 250 (that is, the right side in FIG. 5) when viewed in the front to rear direction. The upper edge 83 constitutes an edge on an upper side of the opening 82.

The inclined wall 84 is formed in a plate shape and extends obliquely downward from a lower end of the side wall 81 toward the transfer cylinder 250 (that is, the right side in FIG. 5) when viewed in the front to rear direction. The bottom wall 85 is formed in a plate shape and extends from a lower end of the inclined wall 84 toward the transfer cylinder 250 (that is, the right side in FIG. 5) when viewed in the front to rear direction.

The inclined wall 86 is formed in a plate shape and extends obliquely upward from a right end of the bottom wall 85 toward the transfer cylinder 250 (that is, the right side in FIG. 5) when viewed in the front to rear direction. The lower edge 87 is formed in a plate shape and extends upward from an upper end of the inclined wall 86 as viewed in the front to rear direction. The lower edge 87 constitutes an edge on a lower side of the opening 82.

The brush 72 includes a shaft portion 72A and a brush portion 72B provided on an outer periphery of the shaft portion 72A. The brush portion 72B is disposed over the entire circumference of the shaft portion 72A. The brush portion 72B includes fibers that extend radially outward from the shaft portion 72A. As the fibers, for example, resin fibers such as polyethylene terephthalate (PET) is used. A fiber diameter of the fiber is, for example, 2d (denier) or more and 15d (denier) or less. A fiber density is, for example, 10,000 fibers/inch² or more and 120,000 fibers/inch² or less. A part of the brush portion 72B in the circumferential direction is a contact portion that comes into contact with the outer peripheral surface of the transfer cylinder 250.

Specifically, the brush 72 is housed inside the housing 80. The contact portion of the brush portion 72B to the transfer cylinder 250 is exposed through the opening 82. Then, the contact portion of the brush portion 72B is in contact with the outer peripheral surface of the transfer cylinder 250 when the body 40 is at the approach position as shown in FIG. 4.

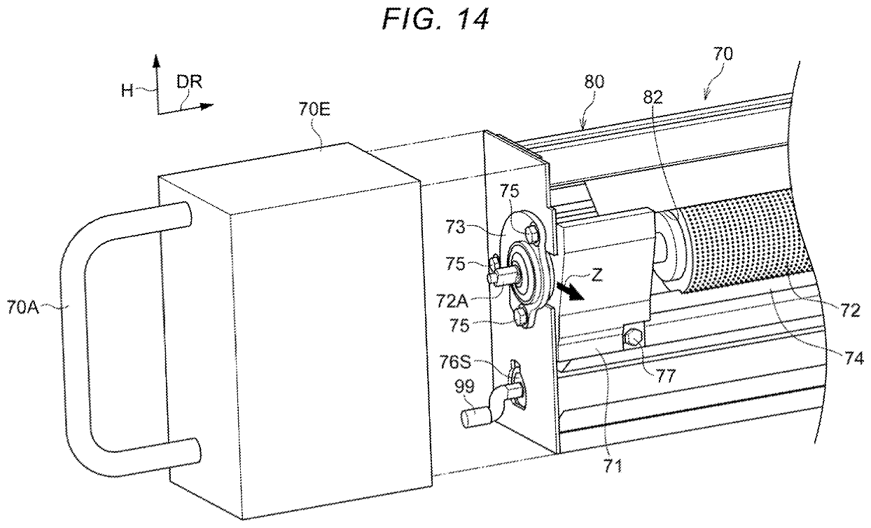

The shaft portion 72A of the brush 72 extends in the front to rear direction of the apparatus. Both end portions of the shaft portion 72A in the axial direction are rotatably supported by the body 40 of the cleaning device 40 via bearings 73 (see FIG. 14). The shaft portion 72A of the brush 72 is driven by a driving unit (not illustrated), so that the brush 72 rotates in a forward direction with respect to a rotation direction of the transfer cylinder 250. That is, while the transfer cylinder 250 rotates in a counterclockwise direction in FIG. 4, the brush 72 rotates in a clockwise direction in FIG. 4. A circumferential speed ratio of the brush 72 to the transfer cylinder 250 is more than 1. That is, the circumferential speed of the brush 72 is faster than the circumferential speed of the transfer cylinder 250. In the present exemplary embodiment, the circumferential speed ratio of the brush 72 to the transfer cylinder 250 is in a range of, for example, 1 and 2.5 (inclusive). The circumferential speed of the brush 72 is a circumferential speed of a tip of a part that does not penetrate into the transfer cylinder 250.

In the brush 72, each part of the brush portion 72B in the circumferential direction repeatedly comes into contact with and separates from the outer peripheral surface of the transfer cylinder 250 as the brush portion 72B rotates. Then, the brush portion 72B elastically deformed by coming into contact with the outer peripheral surface of the transfer cylinder 250 elastically returns, to thereby repel the toner adhering to the outer peripheral surface of the transfer cylinder 250, and physically remove the toner from the outer peripheral surface.

The brush 72 may remove the toner from the outer peripheral surface of the transfer cylinder 250 by electrostatic force in addition to or instead of the physical removal described above.

The flicker 74 is disposed below the brush 72 and is in contact with the brush portion 72B. The flicker 74 is formed in a rod shape and has a circular cross section. The flicker 74 contacts with the rotating brush 72 to drop the toner adhering to the brush 72. The dropped toner is accommodated inside the housing 80 and accumulates on the bottom wall 85 inside the housing 80.

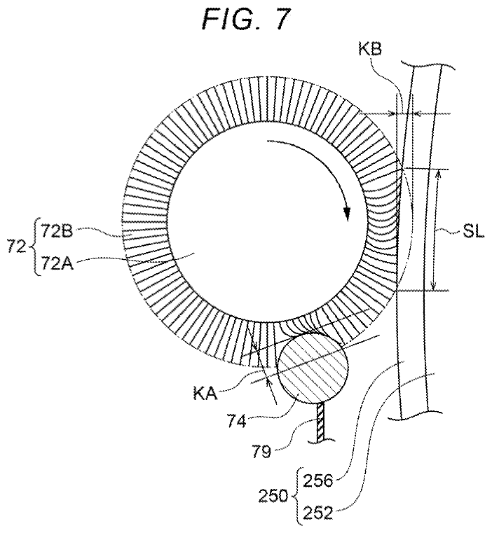

In the present exemplary embodiment, as shown in FIG. 7, KA>KB, where KA is a penetration depth of the brush 72 into the flicker 74, and KB is a penetration depth of the brush 72 into the transfer cylinder 250. The penetration depth KA is a length by which the brush 72 and the flicker 74 overlap each other in a radial direction of the brush 72. The penetration depth KB is a length by which the brush 72 and the transfer cylinder 250 overlap each other in a radial direction of the brush 72. In the present exemplary embodiment, the penetration depth KA is, for example, 0.5 mm or more and 3.0 mm or less, and the penetration depth KB is, for example, 0.3 mm or more and 2.8 mm or less. The length of the fibers of the brush portion 72B (that is, the length of the brush portion 72B in the radial direction) is, for example, 4 mm or more and 10 mm or less, and the distance between the shaft portion 72A of the brush 72 and the transfer cylinder 250 is 1.2 mm or more and 9.7 mm or less.

As shown in FIG. 5, the transport auger 76 is disposed on the bottom wall 85 inside the housing 80. The transport auger 76 includes a shaft portion 76A and a blade portion 76B having a spiral shape. The blade portion 76B is disposed on the outer periphery of the shaft portion 76A.

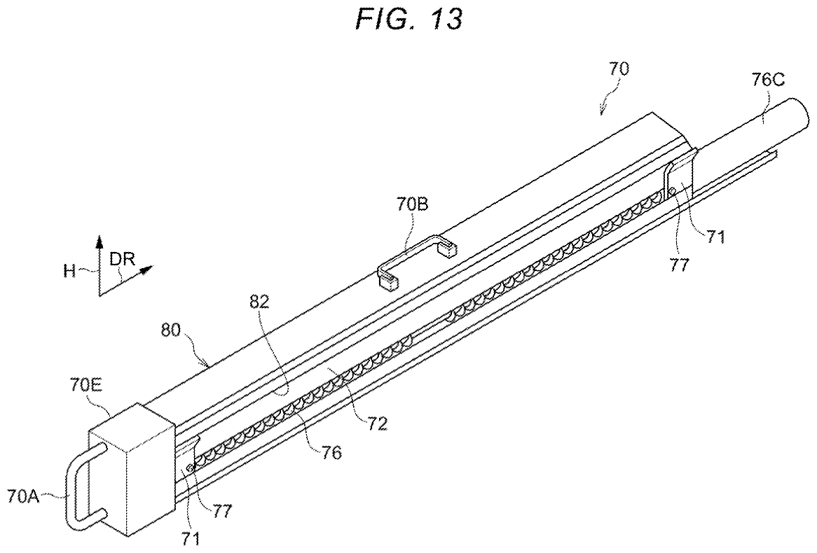

The shaft portion 76A of the transport auger 76 extends in the front to rear direction of the image forming apparatus 10. Both end portions of the shaft portion 76A in the axial direction are rotatably supported by the body 40. In the transport auger 76, as the shaft portion 76A rotates, the blade portion 76B rotates to transport the toner dropped onto the bottom wall 85 inside the housing 80 rearward along the axial direction of the brush 72, and discharge the toner from a rear end (an example of one end in the axial direction) of the housing 80 through a discharge pipe 76C (see FIG. 13).

The seal members 78 and 79 have a function of preventing the toner accommodated inside the housing 80 from leaking to an outside of the housing 80 through the opening 82 of the housing 80. Each of the seal members 78 and 79 is formed of, for example, a flexible and deformable film material.

As shown in FIG. 5, the seal member 78 is attached to the upper edge 83 of the housing 80. Specifically, the seal member 78 extends obliquely downward from the upper edge 83 toward the transfer cylinder 250 (that is, the right side in FIG. 5), and a tip portion of the seal member 78 is in contact with the outer peripheral surface of the transfer cylinder 250. With this configuration, the seal member 78 prevents leakage of the toner through a gap between the upper edge 83 of the housing 80 and the outer peripheral surface of the transfer cylinder 250.

The seal member 79 is attached to the lower edge 87 of the housing 80. Specifically, the seal member 79 extends upward from the lower edge 87, and a tip portion of the seal member 79 is in contact with the flicker 74. With this configuration, the seal member 79 prevents leakage of the toner through the gap between the lower edge 87 of the housing 80 and the flicker 74.

The duct frame 60 is a frame that is an element constituting ducts 91 and 92. In the present exemplary embodiment, the ducts 91 and 92 are defined by the duct frame 60 and the housing 80 of the detachable unit 70. Specifically, the duct frame 60 includes, for example, side walls 61 and 65, an upper wall 62, inclined walls 63 and 66, and a bottom wall 64.

The side wall 61 is disposed on an opposite side (left side in FIG. 5) of the side wall 81 in the housing 80 of the detachable unit 70 to the transfer cylinder 250. The side wall 61 is formed in a plate shape and extends in the height direction as viewed in the front to rear direction. Specifically, the side wall 61 extends to an upper side of the upper wall 89 and the lower side of the bottom wall 85 of the housing 80 of the detachable unit 70.

The upper wall 62 is formed in a plate shape and extends from an upper end of the side wall 61 toward the transfer cylinder 250 (that is, the right side in FIG. 5) when viewed in the front to rear direction. The inclined wall 63 is formed in a plate shape and extends obliquely downward from the right end of the upper wall 62 toward the transfer cylinder 250 (that is, the right side in FIG. 5) when viewed in the front to rear direction.

The bottom wall 64 is formed in a plate shape and extends from a lower end of the side wall 61 toward the transfer cylinder 250 (that is, the right side in FIG. 5) when viewed in the front to rear direction. The side wall 65 is formed in a plate shape and extends upward from a right end of the bottom wall 64 as viewed in the front to rear direction. The inclined wall 66 is formed in a plate shape and extends obliquely upward from an upper end of the side wall 65 toward the transfer cylinder 250 (that is, the right side in FIG. 5) when viewed in the front to rear direction.

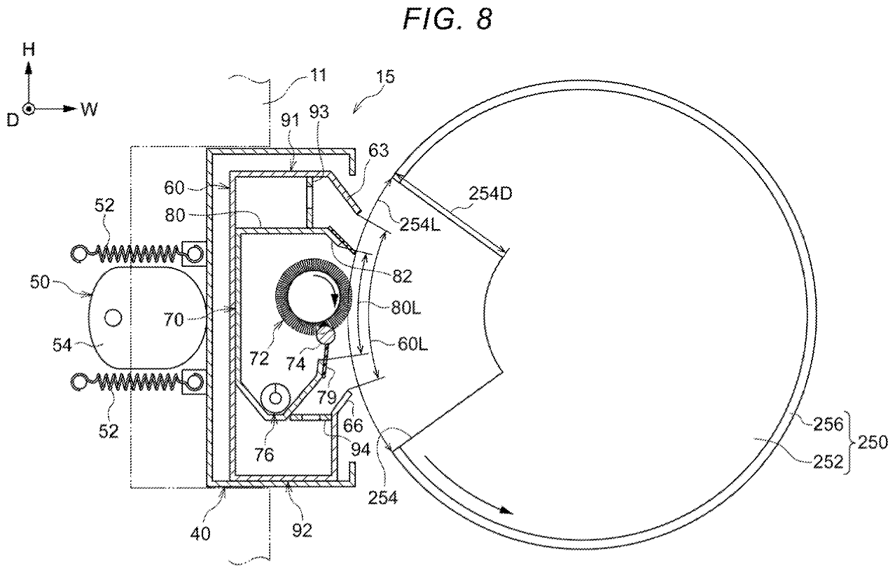

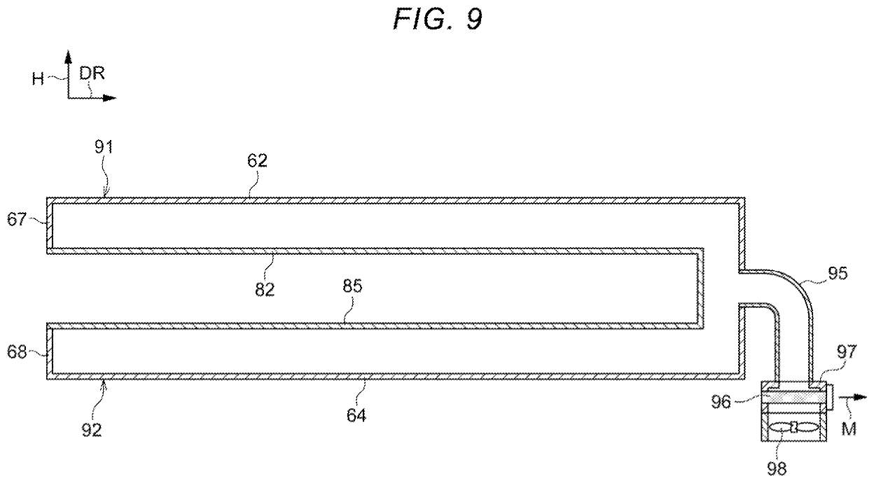

The duct 91 is disposed above the brush 72 and above the upper wall 89 of the housing 80. The duct 91 is defined by the upper wall 89 and the upper edge 83 of the housing 80, an upper portion of the side wall 61 of the duct frame 60, the upper wall 62, and the inclined wall 63. The duct 91 has a suction port 91A between the upper edge 83 of the housing 80 and the inclined wall 63 of the duct frame 60. The suction port 91A opens toward the transfer cylinder 250. As shown in FIG. 8, when the transfer cylinder 250 is at a rotation position where the recess 254 of the transfer cylinder 250 opposes the brush 72 (that is, a left side in FIG. 5), the suction port 91A opposes the recess 254. Furthermore, the suction port 91A is disposed between the transfer belt 213 (specifically, the secondary transfer position T2) and the brush 72. That is, the suction port 91A is opened at a position below the transfer belt 213 (secondary transfer position T2) and above the brush 72. As shown in FIG. 9, the duct 91 extends in the front to rear direction. A front wall 67 that closes the front side of the duct 91 is provided on a front side of the duct 91.

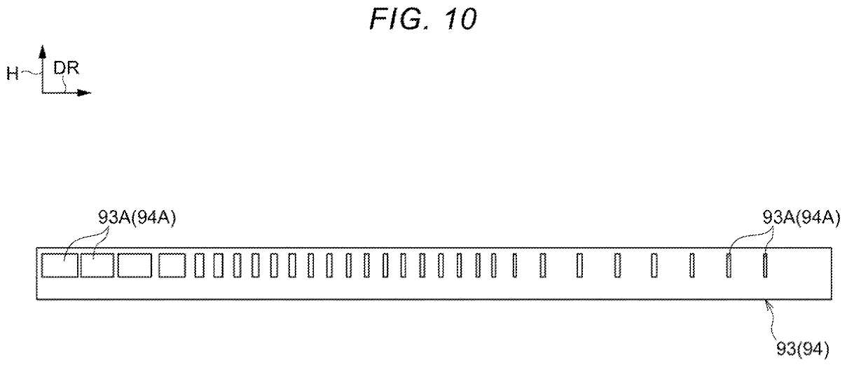

Further, as shown in FIG. 5, a partition plate 93 is provided inside the duct 91. Specifically, the partition plate 93 is disposed between the suction port 91A and the side wall 61 and between the upper wall 62 of the duct frame 60 and the upper wall 89 of the housing 80. The partition plate 93 partitions the inside of the duct 91 into a space 91X on the suction port 91A side and a space 91Y on the side wall 61 side. As shown in FIG. 10, plural openings 93A are formed in the partition plate 93. An opening area of the opening 93A at a rear end portion of the partition plate 93 is smaller than an opening area of the opening 93A at a front end portion of the partition plate 93. Specifically, the plural openings 93A stepwisely decrease in size and increase in interval from the front side toward the rear side.

As shown in FIG. 5, the duct 92 is disposed below the brush 72 and below the bottom wall 85 of the housing 80. The duct 92 is defined by the inclined walls 84 and 86, the bottom wall 85 and the lower edge 87 of the housing 80, a lower portion of the side wall 61, the bottom wall 64, the side wall 65, and the inclined wall 66 of the duct frame 60. The duct 92 has a suction port 92A between the lower edge 87 of the housing 80 and the inclined wall 66 of the duct frame 60. The suction port 92A opens toward the transfer cylinder 250. As shown in FIG. 8, when the transfer cylinder 250 is at the rotation position where the recess 254 of the transfer cylinder 250 opposes the brush 72 (that is, the left side in FIG. 5), the suction port 92A opposes the recess 254. Furthermore, the suction port 92A is disposed on the opposite side of the brush 72 to the transfer belt 213 (specifically, the secondary transfer position T2). That is, the suction port 92A is opened at a position below the brush 72. As shown in FIG. 9, the duct 92 extends in the front to rear direction. A front wall 68 that closes the front side of the duct 92 is provided on a front side of the duct 92.

Further, as shown in FIG. 5, a partition plate 94 is provided inside the duct 92. Specifically, the partition plate 94 is disposed between the suction port 92A and the side wall 64 and between the side wall 65 of the duct frame 60 and the bottom wall 85 of the housing 80. The partition plate 94 partitions the inside of the duct 92 into a space 92X on the suction port 92A side and a space 92Y on the bottom wall 64 side. The partition plate 94 has an opening 94A, like the partition plate 93 (see FIG. 10).

As shown in FIG. 9, the duct 91 and the duct 92 are coupled to each other on the rear side. One end portion of a flexible tube 95 (such as a hose) is connected to a side wall 61 side (that is, the space 91Y and the space 92Y side, see FIG. 5) of the coupling portion between the duct 91 and the duct 92. An accommodation portion 97 in which a filter 96 is accommodated is connected to the other end portion of the tube 95. The filter 96 can be pulled out from the accommodating unit 97 in an arrow M direction, and can be replaced with a new filter 96.

Further, a blower 98 is provided below the accommodating portion 97. When the blower 98 is driven, air containing the toner is taken into the duct 91 through the suction port 91A and is taken into the duct 92 through the suction port 92A. The air taken into the duct 91 flows to the rear side while passing through the opening 93A of the partition plate 93. The air taken into the duct 92 flows to the rear side while passing through the opening 94A of the partition plate 94, merges with the air flowing through the duct 91, passes through the pipe 95 and the filter 96, and is discharged. In the present exemplary embodiment, since the rear side of the ducts 91 and 92 is a suction side of the blower 98, opening areas of the partition plates 93 and 94 are decreased in size on a rear end side, and thereby a variation in an air volume in the front to rear direction is prevented.

### Positional Relationship Between Respective Elements of Cleaning Device 15

As shown in FIG. 4, the secondary transfer position T2 is disposed above the brush 72 and above the transfer cylinder 250. When the outer peripheral surface of the transfer cylinder 250 is equally divided into a downstream portion and an upstream portion in the rotation direction of the transfer cylinder 250 with reference to the secondary transfer position T2, the brush 72 is in contact with the downstream portion (specifically, a portion on a left half side in FIG. 4). Further, consider the secondary transfer position T2 relative to the transfer cylinder 250 and the position of the brush 72 relative to the transfer cylinder 250 when the transfer cylinder 250 corresponds to a dial of a timepiece. In this case, the secondary transfer position T2 is at the twelve o'clock position on the transfer cylinder 250, the brush 72 is located between the eight o'clock position and the ten o'clock position, for example.

When the brush 72 is equally divided into a downstream portion and an upstream portion in the rotation direction with reference to a contact position 72S of the brush 72 to the outer peripheral surface of the transfer cylinder 250, the flicker 74 is in contact with the downstream portion. That is, the flicker 74 is in contact with a lower half portion of the brush 72. Further, consider the contact position 72S to the transfer cylinder 250 with respect to the brush 72 and a position of the flicker 74 with respect to the brush 72 when the brush 72 corresponds to a dial of a timepiece. In this case, the contact position 72S is at the three o'clock position on the flicker 72, and the flicker 74 is located between the four o'clock position and the six o'clock position, for example.

The secondary transfer position T2 is located above the brush 72, whereas the flicker 74 is disposed below the brush 72. That is, the flicker 74 is disposed on the opposite side of the brush 72 to a side where the secondary transfer position T2 is located.

### Relationship Between Respective Elements of Cleaning Device 15 and Recess 254 of Transfer Cylinder 250

As shown in FIG. 8, one recess 254 of the transfer cylinder 250 is provided in a part of the outer peripheral surface of the transfer cylinder 250 in the circumferential direction. The recess 254 is elongated along the axial direction of the transfer cylinder 250 and has a depth along the radial direction of the transfer cylinder 250.

An opening width 254L (see FIG. 8) of the recess 254 as viewed in the axial direction is wider than a contact width SL (see FIG. 7) between the brush 72 and the outer peripheral surface of the transfer cylinder 250 as viewed in the axial direction. A depth 254D (see FIG. 8) of the recess 254 is deeper than the penetration depth KB (see FIG. 7) of the brush 72 into the transfer cylinder 250.z Therefore, in a state in which the brush 72 opposes the recess 254, the brush 72 is not in contact with the transfer cylinder 250, and a state in which the brush 72 penetrates into the transfer cylinder 250 is released. Further, the opening width 254L of the recess 254 is wider than the outer diameter of the brush 72, wider than an opening width 80L of the opening 82 of the housing 80 as viewed in the axial direction, and wider than a width 60L between the tip of the inclined wall 63 and the tip of the inclined wall 66 of the duct frame 60 as viewed in the axial direction. The opening width 254L, the contact width SL, the opening width 80L, and the width 60L are widths along the circumferential direction of the transfer cylinder 250.

### Configuration of Detachable Unit 70 and Configuration for Attaching and Detaching Detachable Unit 70

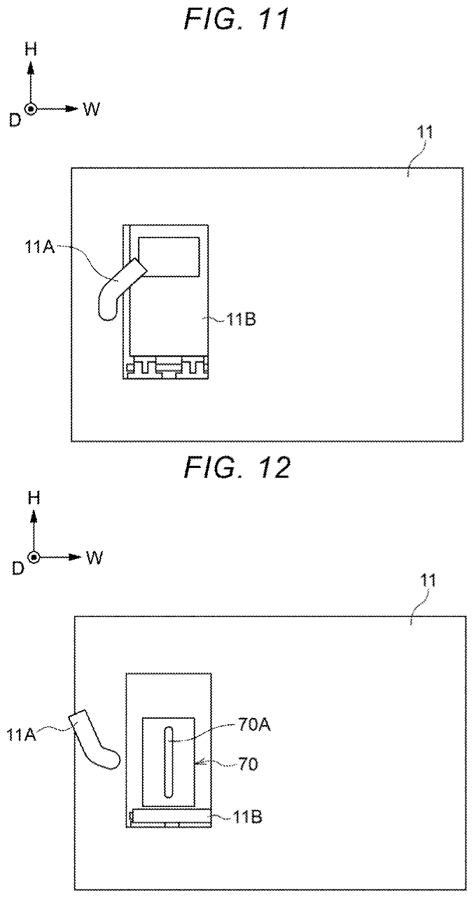

As shown in FIGS. 11 and 12, a lever 11A provided in the body 11 of the image forming apparatus 10 is swung from a closed position shown in FIG. 11 to an open position shown in FIG. 12, and a front cover 11B is tilted forward and opened, so that the detachable unit 70 including the housing 80 becomes detachable. Specifically, the detachable unit 70 including the housing 80 becomes detachable as follows.

In the present exemplary embodiment, a swing shaft of the lever 11A is formed integrally with the swing shaft 54A of the cam 54. By swinging the lever 11A to the open position, the cam 54 swings, and the shorter diameter portion of the cam 54 opposes the side wall 42B of the housing 42, thereby moving the body 40 to the separated position shown in FIG. 6 by the elastic force of the tension springs 52. The front cover 11B is disposed on the front side of the detachable unit 70 when the body 40 is in the separated position. When the front cover 11B is opened, the detachable unit 70 becomes detachable. In the present exemplary embodiment, the detachable unit 70 including the housing 80 can be detached from the body 40 while the duct frame 60 constituting the ducts 91 and 92 remains in the body 40.

As shown in FIGS. 12 and 13, a handle 70A is provided on the front side of the detachable unit 70. The detachable unit 70 can be pulled out from the body 11 of the image forming apparatus 10 by pulling the handle 70A. A box-shaped structure 70E provided with the handle 70A is detachably attached to the housing 80 (see FIG. 14). Further, as shown in FIG. 13, a carrying handle 70B is provided at an upper portion of the detachable unit 70. In FIG. 13, illustration of the flicker 74 is omitted.

As shown in FIG. 13, the detachable unit 70 includes side seal members 71 that seal the opening 82 of the housing 80 at both ends of the brush 72 in the axial direction. The side seal members 71 are detachably provided in the housing 80. Specifically, as shown in FIG. 14, each side seal member 71 is attached to the housing 80 by screwing the side sealing member 71 to the housing 80 with a screw 77, and can be removed from the housing 80 by removing the screw 77. The side seal member 71 are an example of a sealing portion.

The bearings 73 that support both end portions of the shaft portion 72A of the brush 72 are detachably provided in the housing 80. Specifically, as shown in FIG. 14, each bearing 73 is attached to the housing 80 by screwing the bearing 73 to the housing 80 with a screw 75. Each bearing 73 can be removed from the housing 80 from the opening 82 side in an arrow Z direction by removing the screw 75 in the state in which the side seal members 71 and the structure 70E are removed.

The side seal members 71 and the brush 72 is detachable from the housing 80 in a state in which the detachable unit 70 is detached from the body 11 of the image forming apparatus 10.

A connection portion 76S is provided at a front end portion of the shaft portion 76A (see FIG. 5) of the transport auger 76. As shown in FIG. 14, in a state in which (i) the detachable unit 70 is detached from the body 11 of the image forming apparatus 10 and (ii) the structure 70E is detached, a handle 99 is connected to the connection portion 76S of the shaft portion 76A from the front side. An operator performs an operation of rotating the transport auger 76 relative to the handle 99. The operator also attaches a storage bag or the like to the discharge pipe 76C (see FIG. 13) on the rear side of the housing 80. In response to the operation of rotating the transport auger 76, the toner is discharged to the storage bag through the discharge pipe 76C. The handle 99 is an example of an operation unit.

### Effect of the Present Exemplary Embodiment

According to the present exemplary embodiment, as described above, the brush 72 which is in contact with the outer peripheral surface of the transfer cylinder 250 removes the toner adhering to the outer peripheral surface of the transfer cylinder 250 (see FIG. 4).

Here, consider a configuration in which a blade is pressed against the outer peripheral surface of the transfer cylinder 250 to remove a toner adhering to the outer peripheral surface (hereinafter, which will be referred to as a “configuration A”). Since the recess 254 is formed in the outer peripheral surface of the transfer cylinder 250, the blade may collide with an edge of the recess 254, thereby causing the blade and the transfer cylinder 250 to vibrate. When the blade and the transfer cylinder 250 vibrate, the toner adhering to the blade and the transfer cylinder 250 may get brown up, the toner may adhere to a non-transfer surface of the recording medium P passing the secondary transfer position T2, and the non-transfer surface may be contaminated.

In the configuration A, when the recess 254 formed in the outer peripheral surface of the transfer cylinder 250 opposes the blade, a posture of the blade is likely to be changed, and a pressing force of the blade against the outer peripheral surface is likely to be changed. Therefore, in the configuration A, the toner may not be completely removed from the outer peripheral surface, and the toner may remain on the outer peripheral surface. If the toner remains on the outer peripheral surface of the transfer cylinder 250, the toner may adhere to the non-transfer surface of the recording medium P passing the secondary transfer position T2, and the non-transfer surface may be contaminated.

In contrast, in the present exemplary embodiment, the toner adhering to the outer peripheral surface of the transfer cylinder 250 is removed with the brush 72. Therefore, the occurrence of fluctuation in the contact pressure with respect to the transfer cylinder 250 and the occurrence of vibration at the edges of the recess 254 are prevented as compared to the configuration A. Therefore, in the present exemplary embodiment, contamination of the non-transfer surface of the recording medium is prevented as compared to the configuration A.

In the present exemplary embodiment, the brush 72 rotates in the forward direction relative to the rotation direction of the transfer cylinder 250. Here, consider a configuration in which the brush 72 rotates in a direction opposite to the rotation direction of the transfer cylinder 250 (hereinafter, which will be referred to as a “configuration B”). Since the brush 72 rotates against the rotation direction of the transfer cylinder 250, the fibers of the brush 72 are more repelled than in the case in which the brush 72 rotates in the forward direction. As a result, the toner adhering to the brush 72 is likely to get brown up. In the case where the configuration B is adopted in the present exemplary embodiment, the brush 72 moves upward at the contact portion to the transfer cylinder 250, and therefore, in particular, the toner is likely to get brown up. In the case of adopting the configuration B, since the toner is likely to get brown up, it may be attempted to use the configuration B with a decreased rotation speed. However, in this case, the number of times the brush 72 comes into contact with the flicker 74 decreases, and the performance of removing the toner from the brush 72 decreases.

In contrast, in the present exemplary embodiment, the brush 72 rotates in the forward direction relative to the rotation direction of the transfer cylinder 250 as described above. As compared to the configuration B, the toner is less likely to get brown up, and a toner cloud is prevented.

In the present exemplary embodiment, the circumferential speed ratio of the brush 72 to the transfer cylinder 250 is more than 1. Therefore, the performance of removing the toner by the brush 72 is improved as compared to a configuration in which the circumferential speed ratio of the brush 72 to the transfer cylinder 250 is 1 or less.

As shown in FIG. 4, in the present exemplary embodiment, when the outer peripheral surface of the transfer cylinder 250 is equally divided into the downstream portion and the upstream portion in the rotation direction of the transfer cylinder 250 with reference to the secondary transfer position T2, the brush 72 is in contact with the downstream portion (a portion on the left half side in FIG. 5).

Therefore, as compared to a configuration in which the brush 72 is in contact with the upstream portion, a distance along the rotation direction of the transfer cylinder 250 from the secondary transfer position T2 to the contact position of the brush 72 to the outer peripheral surface of the transfer cylinder 250 is shortened. As a result, after the toner adheres to the transfer cylinder 250 at the secondary transfer position T2, the toner is removed by the brush 72 in a short time, so that it is prevented that the toner cloud is generated from the transfer cylinder 250.

In the present exemplary embodiment, the flicker 74 contacts with the rotating brush 72 to drop the toner adhering to the brush 72. Therefore, as compared to a configuration in which the brush 72 is in contact with only the transfer cylinder 250, a re-adhesion of toner from the brush 72 to the transfer cylinder 250 is prevented.

In the present exemplary embodiment, as shown in FIG. 7, KA>KB, where KA is the penetration depth of the brush 72 into the flicker 74, and KB is the penetration depth of the brush 72 into the transfer cylinder 250. Therefore, as compared to a configuration in which KA≤KB, the toner that has moved from the transfer cylinder 250 to the brush 72 is likely to be dropped from the brush 72, and the re-adhesion of toner from the brush 72 to the transfer cylinder 250 is prevented.

In the present exemplary embodiment, when the brush 72 is equally divided into the downstream portion and the upstream portion in the rotation direction with reference to the contact position of the brush 72 to the outer peripheral surface of the transfer cylinder 250, the flicker 74 is in contact with the downstream portion. That is, the flicker 74 is in contact with a lower half portion of the brush 72.

Therefore, as compared to a configuration in which the flicker 74 is in contact with the upstream portion, a distance along the rotation direction of the brush 72 from the contact position of the brush 72 to the outer peripheral surface of the transfer cylinder 250 to the contact position of the flicker 74 to the brush 72 is shortened. As a result, after the toner adheres to the brush 72 at the contact position to the transfer cylinder 250, the toner is dropped by the brush 72 in a short time, so that it is prevented that the toner cloud is generated from the brush 72.

In the present exemplary embodiment, the secondary transfer position T2 is disposed above the brush 72, whereas the flicker 74 is disposed below the brush 72.

Therefore, as compared to a configuration in which the flicker 74 is disposed above the brush 72, the non-transfer surface of the recording medium P passing through the secondary transfer position T2 is prevented from being contaminated by the toner cloud generated at the contact position between the flicker 74 and the brush 72.

In the present exemplary embodiment, the brush 72 is provided in the housing 80 so as to be detachably attached to the housing 80 of the detachable unit 70 which is in a state of being detached from the body 11 of the image forming apparatus 10. Since the brush 72 alone can be replaced, a component replacement cost is reduced as compared to a configuration in which the brush 72 cannot be detached from the housing 80.

In the present exemplary embodiment, the side seal members 71 that seal the opening 82 of the housing 80 at both ends of the brush 72 in the axial direction are detachably provided in the housing 80. Since the side seal member 71 alone can be replaced, a component replacement cost is reduced as compared to a configuration in which the side seal member 71 cannot be detached from the housing 80.

In the present exemplary embodiment, in a state in which the detachable unit 70 is detached from the body 11 of the image forming apparatus 10, the operator performs a rotation operation on the handle 99 connected to the connection portion 76S of the transport auger 76, to thereby discharge the toner dropped into the housing 80.

Therefore, a mechanism that collects the toner is simplified as compared to a configuration in which the toner dropped into the housing 80 is discharged from the housing 80 in a state in which the detachable unit 70 is attached to the body 11 of the image forming apparatus 10. Specifically, the driving unit of the transport auger 76 and the accommodating portion that accommodates the toner are unnecessary.

### Modifications

In the present exemplary embodiment, the transfer belt 213 (serving as the intermediate transfer body) is used as an example of the transfer portion. This configuration is intended to be illustrative only, and should not be construed in any limiting sense. As an example of the transfer portion, a photoconductor may be used. Alternatively, a direct transfer type transfer portion may be used.

In the present exemplary embodiment, the brush 72 rotates in the forward direction relative to the rotational direction of the transfer cylinder 250. This configuration is intended to be illustrative only, and should not be construed in any limiting sense. For example, the brush 72 may rotate in the opposite direction relative to the rotational direction of the transfer cylinder 250. Also, the brush 72 may not rotate. In this case, for example, the flicker 74 is unnecessary.

In the present exemplary embodiment, the circumferential speed ratio of the brush 72 to the transfer cylinder 250 is more than 1. This configuration is intended to be illustrative only, and should not be construed in any limiting sense. The circumferential speed ratio of the brush 72 to the transfer cylinder 250 may be 1 or less.

As shown in FIG. 4, in the present exemplary embodiment, when the outer peripheral surface of the transfer cylinder 250 is equally divided into the downstream portion and the upstream portion in the rotation direction of the transfer cylinder 250 with reference to the secondary transfer position T2, the brush 72 is in contact with the downstream portion (a part on the left half side in FIG. 4). This configuration is intended to be illustrative only, and should not be construed in any limiting sense. For example, the brush 72 may be in contact with the upstream portion.

In the present exemplary embodiment, the flicker 74 is provided. Alternatively, the flicker 74 may not be provided.

In the present exemplary embodiment, as shown in FIG. 7, KA>KB, where KA is the penetration depth of the brush 72 into the flicker 74, and KB is the penetration depth of the brush 72 into the transfer cylinder 250. This configuration is intended to be illustrative only, and should not be construed in any limiting sense. For example, a relationship of KA≤KB may be met.

In the present exemplary embodiment, when the brush 72 is equally divided into the downstream portion and the upstream portion in the rotation direction with reference to the contact position of the brush 72 to the outer peripheral surface of the transfer cylinder 250, the flicker 74 is in contact with the downstream portion. This configuration is intended to be illustrative only, and should not be construed in any limiting sense. For example, the flicker 74 may be in contact with the upstream portion.

In the present exemplary embodiment, the secondary transfer position T2 is disposed above the brush 72, whereas the flicker 74 is disposed below the brush 72. This configuration is intended to be illustrative only, and should not be construed in any limiting sense. For example, the flicker 74 may be disposed above the brush 72.

In the present exemplary embodiment, the brush 72 is provided in the housing 80 to be detachably attached to the housing 80 of the detachable unit 70 which is in the state of being detached from the body 11 of the image forming apparatus 10. This configuration is intended to be illustrative only, and should not be construed in any limiting sense. For example, the brush 72 may not be detachable from the housing 80, and the entire detachable unit 70 may be replaceable.

In the present exemplary embodiment, the side seal members 71 that seal the opening 82 of the housing 80 at both ends of the brush 72 in the axial direction are detachably provided in the housing 80. This configuration is intended to be illustrative only, and should not be construed in any limiting sense. For example, the side seal members 71 may not be detachable from the housing 80, and the entire detachable unit 70 may be replaceable.

In the configuration according to the present exemplary embodiment, in the state in which the detachable unit 70 is detached from the body 11 of the image forming apparatus 10, the operator performs the rotation operation on the handle 99 connected to the connection portion 76S of the transport auger 76, to thereby discharge the toner dropped into the housing 80. This configuration is intended to be illustrative only, and should not be construed in any limiting sense. For example, the toner dropped into the housing 80 may be discharged from the housing 80 in a state in which the detachable unit 70 is attached to the body 11 of the image forming apparatus 10.

The present disclosure is not limited to the above exemplary embodiment. Various modifications, changes, and improvements may be made without departing from the scope of the present disclosure. For example, the modifications described above may be combined with each other as appropriate.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
a rotating body having a recess in an outer peripheral surface thereof;
a transfer portion that is in contact with the outer peripheral surface of the rotating body, the transfer portion being configured to transfer a toner to a recording medium passing between the rotating body and the transfer portion; and
a brush configured to come into contact with the outer peripheral surface of the rotating body to remove a toner adhering to the outer peripheral surface.

2. The image forming apparatus according to claim 1, wherein the brush is configured to rotate in a forward direction relative to a rotational direction of the rotating body.

3. The image forming apparatus according to claim 2, wherein a circumferential speed ratio of the brush to the rotating body is more than 1.

4. The image forming apparatus according to claim 1, wherein
when the outer peripheral surface is equally divided into a downstream portion and an upstream portion in a rotation direction of the rotating body with reference to a contact position of the transfer portion to the outer peripheral surface of the rotating body, the brush comes into contact with the downstream portion.

5. The image forming apparatus according to claim 2, wherein
when the outer peripheral surface is equally divided into a downstream portion and an upstream portion in a rotation direction of the rotating body with reference to a contact position of the transfer portion to the outer peripheral surface of the rotating body, the brush comes into contact with the downstream portion.

6. The image forming apparatus according to claim 3, wherein
when the outer peripheral surface is equally divided into a downstream portion and an upstream portion in a rotation direction of the rotating body with reference to a contact position of the transfer portion to the outer peripheral surface of the rotating body, the brush comes into contact with the downstream portion.

7. The image forming apparatus according to claim 1, further comprising:
a contact member, wherein
the brush rotates, and
the contact member is configured to come into contact with the rotating brush to drop the toner adhering to the brush.

8. The image forming apparatus according to claim 2, further comprising:
a contact member, wherein
the brush rotates, and
the contact member is configured to come into contact with the rotating brush to drop the toner adhering to the brush.

9. The image forming apparatus according to claim 3, further comprising:
a contact member, wherein
the brush rotates, and
the contact member is configured to come into contact with the rotating brush to drop the toner adhering to the brush.

10. The image forming apparatus according to claim 4, further comprising:
a contact member, wherein
the brush rotates, and
the contact member is configured to come into contact with the rotating brush to drop the toner adhering to the brush.

11. The image forming apparatus according to claim 5, further comprising:
a contact member, wherein
the brush rotates, and
the contact member is configured to come into contact with the rotating brush to drop the toner adhering to the brush.

12. The image forming apparatus according to claim 6, further comprising:
a contact member, wherein
the brush rotates, and
the contact member is configured to come into contact with the rotating brush to drop the toner adhering to the brush.

13. The image forming apparatus according to claim 7, wherein
KA>KB, where
KA is a penetration depth of the brush into the contact member, and
KB is a penetration depth of the brush into the rotating body.

14. The image forming apparatus according to claim 8, wherein
KA>KB, where
KA is a penetration depth of the brush into the contact member, and
KB is a penetration depth of the brush into the rotating body.

15. The image forming apparatus according to claim 9, wherein
KA>KB, where
KA is a penetration depth of the brush into the contact member, and
KB is a penetration depth of the brush into the rotating body.

16. The image forming apparatus according to claim 7, wherein
when the brush is equally divided into a downstream portion and an upstream portion in a rotation direction with reference to a contact position of the brush to the outer peripheral surface of the rotating body, the contact member is in contact with the downstream portion.

17. The image forming apparatus according to claim 7, wherein
a contact position of the transfer portion to the outer peripheral surface of the rotating body is located above the brush, and
the contact member is located below the brush.

18. The image forming apparatus according to claim 1, further comprising:
a housing detachably provided in a body of the image forming apparatus, the housing accommodating the brush therein, the housing having an opening through which a contact portion of the brush to the rotating body is exposed, wherein
the brush is detachably provided in the housing which is in a state of being detached from the body of the image forming apparatus.

19. The image forming apparatus according to claim 1, further comprising:
a housing detachably provided in a body of the image forming apparatus, the housing accommodating the brush therein, the housing having an opening through which a contact portion of the brush to the rotating body is exposed; and
sealing portions that are detachably provided in the housing, the sealing portions sealing the opening at both ends of the brush in an axial direction.

20. The image forming apparatus according to claim 1, further comprising:
a housing that is detachably provided in a body of the image forming apparatus, the housing accommodating the brush therein, the housing having an opening through which a contact portion of the brush relative to the rotating body is exposed;
a transport member configured to rotate to transport a toner dropped from the brush to an inside of the housing along an axial direction of the brush and discharge the toner from one end of the housing in the axial direction; and
an operation unit that is to be connected to the transport member from another end side of the housing in the axial direction in a state in which the housing is detached from the body of the image forming apparatus, and that is to be operated by an operator to rotate the transport member.
